(19) United States
(12) Patent Application Publication
(10) Pub. No.: US 2026/0065116 A1
(43) Pub. Date: Mar. 5, 2026

(54) METHODS AND SYSTEMS FOR DOPPLER-FREE SINGLE-PHOTON EXCITATION OF ATOMS VIA MOVING POTENTIALS

(71) Applicant: ATOM COMPUTING INC., Berkeley, CA (US)

(72) Inventor: William CAIRNCROSS, Boulder, CO (US)

(21) Appl. No.: 19/195,373

(22) Filed: Apr. 30, 2025

Related U.S. Application Data
(63) Continuation of application No. PCT/US2023/079002, filed on Nov. 7, 2023.
(60) Provisional application No. 63/382,781, filed on Nov. 8, 2022.

(51) Int. Cl. G06N 10/40

(52) U.S. Cl. CPC G06N 10/40

(57) ABSTRACT

A method for transitioning an atom from a first state to a second state with a single photon, wherein a motional state of the atom is preserved, is provided. The method may include: (a) providing a plurality of atoms in a plurality of spatially distinct optical trapping sites, and (b) generating a translating excitation potential in a spatial dimension across a confining potential energy landscape of the first state of the atom of the plurality of atoms, wherein a temporal duration of the translating excitation potential is short relative to a characteristic length of the confining potential energy landscape, thereby transitioning the atom from the first state to the second state.

### CROSS-REFERENCE

This application is the by-pass continuation of International Application No. PCT/US2023/079002, filed Nov. 7, 2023, which claims the benefit of U.S. Provisional Application Ser. No. 63/382,781, filed on Nov. 8, 2022, each of which are incorporated herein by reference in their entirety.

### BACKGROUND

Laser cooling is an important tool for quantum control of atomic systems in a variety of settings. Among these settings are quantum computing, optical lattice clocks, fundamental physics studies, including explorations of many-body physics, quantum information applications, quantum sensing applications, and precision measurements. Laser cooling includes a number of techniques where atoms, molecules, and small mechanical systems are cooled with laser light. This cooling may result in atoms with temperatures less than 100's of microkelvin. This may result in arrays of atoms in definite quantum states with high probability. Laser cooling may result in homogenous arrays of atoms approaching a motional ground state of the atom. Laser cooling may result in arrays of atoms below a doppler cooling limit. Having atoms in known quantum states may be useful for various applications.

### SUMMARY

Absorption of a photon by an atom may include transfer of the photon's momentum to the atom, mathematically expressed as the multiplication by a factor e^{ikx} where k is the photon's momentum vector and x is the atom's position (assuming, for illustrative purposes, a 1-dimensional system without loss of generality). For arrays of trapped atoms, transfer of the photon's momentum may result in a mixing of trap eigenstates. For example, if the atom is initially in a Fock state of trap motion, e.g., possessing a definite number of motional quanta, the excited atom may no longer be in a Fock state, but may exist in a quantum superposition of various motional Fock states. The phase of the resulting superposition state may be rapidly evolving and may not be precisely tracked. Furthermore, the infinite or quasi-infinite number of motional states may act as a reservoir or “bath,” into which the coherence of the quantum state can diffuse. The result of repeated, nominally coherent, absorption and emission (e.g., Rabi flopping) may be eventual decoherence of the atom's motional state—an undesirable result in quantum information applications where coherence is valuable.

Aspects of the present disclosure provide methods and systems to change quantum states of atoms (e.g., exciting an atom from its ground to excited electronic state with a single photon) while preserving the motional state of the atom. Aspects of the present disclosure preserve the motional state of the atom at least in part by canceling the imparted momentum of the photon.

In an aspect, the present disclosure provides a method for preserving a motional state of an atom when said atom is transitioned from a first state to a second state. The method may comprise: (a) providing said atom in said first state, wherein said atom is trapped at a trapping site of a plurality of spatially distinct optical trapping sites by a first state potential, (b) translating a second state potential in a spatial dimension relative to said first state potential; and (c) transitioning said atom to said second state with an excitation electromagnetic energy, and wherein a relative velocity of said second state potential relative to said first state potential substantially counteracts a momentum imparted by a photon of said excitation electromagnetic energy.

In some embodiments, a temporal duration of said excitation electromagnetic energy is short relative to a characteristic length of the first state potential. In some embodiments, said excitation electromagnetic energy is coherent light from a laser. In some embodiments, said plurality of spatially distinct optical trapping sites is generated by a trapping optical source. In some embodiments, said trapping optical source comprises at least two optical sources. In some embodiments, a first trapping optical source is configured to trap said atom in said first state, and wherein a second trapping optical source is configured to trap said atom in said second state. In some embodiments, a trapping wavelength of said first trapping optical source is different than a trapping wavelength of said second trapping optical source. In some embodiments, said second state potential feels substantially no optical dipole force from said first trapping optical source. In some embodiments, said first state potential feels substantially no optical dipole force from said second trapping optical source.

In some embodiments, a characteristic trap frequency of said first state potential is substantially equal to a characteristic trap frequency of said second state potential. In some embodiments, said translating said second state potential in (b) is performed substantially without altering a trapping potential of either said second state or said first state. In some embodiments, a recoil velocity of said excitation electromagnetic energy is about equal to said relative velocity. In some embodiments, said recoil velocity is defined as v=hk/m, where k=2π/λ is the wavenumber of said excitation electromagnetic energy. In some embodiments, a characteristic trap frequency of said first state potential is substantially equal to a characteristic trap frequency of said second state potential. In some embodiments, a characteristic length is defined as aₕₒ\sqrt{h/mω}, where ω is said characteristic trap frequency, and wherein a temporal duration of said excitation electromagnetic energy is short relative to a parameter defined as said characteristic trap length divided by said recoil velocity. In some embodiments, said temporal duration is shorter than said parameter by a factor of three. In some embodiments, said temporal duration is shorter than said parameter by a factor of ten.

In some embodiments, said translating said second state potential in (b) comprises translating a magnetic field or providing a magnetic field gradient, wherein said second state potential and said first state potential exhibit a differential sensitivity to said magnetic field or said magnetic field gradient. In some embodiments, said second state potential is more sensitive to said magnetic field or said magnetic field gradient than said first state potential. In some embodiments, said first state potential is more sensitive to said magnetic field or said magnetic field gradient than said second state potential.

In some embodiments, said translating said second state potential in (b) comprises: trapping said first state and said second state with a trapping optical excitation, wherein said trapping optical excitation is tuned such that said first state and said second state have substantially equal polarizabilities; and applying a potential gradient, and wherein (b) comprises changing said potential gradient in time. In some embodiments, said potential gradient is linear in a spatial dimension. In some embodiments, said potential is an electric potential or a magnetic potential.

In some embodiments, said translating in (b) comprises translating said second state potential, wherein said first state potential is substantially stationary, and wherein said translating is performed substantially without altering said first state potential. In some embodiments, said translating in (b) comprises translating said first state potential, wherein said second state potential is substantially stationary, and wherein said translating is performed substantially without altering said second state potential.

In some embodiments, said plurality of atoms are qubits. In some embodiments, said plurality of atoms comprises neutral atoms. In some embodiments, said plurality of atoms comprises two valence electron atoms. In some embodiments, said atom is Ytterbium. In some embodiments, the method further comprises performing a non-classical computation. In some embodiments, said non-classical computation is a quantum computation.

In some embodiments, the first state is a lower state, and the second state is an upper state. In some embodiments, the lower state is a ground state, and the upper sate is an excited state. In some embodiments, the first state and the second state are electronic states. In some embodiments, the transitioning is an absorption. In some embodiments, the transitioning is an emission.

In another aspect, the present disclosure provides a system for preserving a motional state of an atom when said atom is transitioned between states. The system may comprise: a plurality of spatially distinct optical trapping sites comprising an atom in a site of said plurality of spatially distinct optical trapping sites, wherein said atom is trapped by a first state potential; a trapping optical source, wherein said trapping optical source is operable to translate a second state potential in a spatial dimension relative to said first state potential; and an electromagnetic delivery unit, the electromagnetic delivery unit configured to produce an excitation electromagnetic energy, wherein the excitation electromagnetic energy is configured to excite said atom to said second electronic state, and wherein a relative velocity of said second state potential relative to said first state potential substantially counteracts a momentum imparted by a photon of said excitation electromagnetic energy.

In some embodiments, a temporal duration of said excitation electromagnetic energy is short relative to a characteristic length of the first state potential. In some embodiments, said excitation electromagnetic energy is coherent light from a laser. In some embodiments, said plurality of spatially distinct optical trapping sites is generated by the trapping optical source. In some embodiments, said trapping optical source comprises at least two optical sources. In some embodiments, a first trapping optical source is configured to trap said atom in said first state, and wherein a second trapping optical source is configured to trap said atom in said second state. In some embodiments, a trapping wavelength of said first trapping optical source is different than a trapping wavelength of said second trapping optical source. In some embodiments, said second state potential feels substantially no optical dipole force from said first trapping optical source. In some embodiments, said first state potential feels substantially no optical dipole force from said second trapping optical source.

In some embodiments, a characteristic trap frequency of said first state potential is substantially equal to a characteristic trap frequency of said second state potential. In some embodiments, said trapping optical source is configured to translate said second state potential substantially without altering a trapping potential of either said second state or said first state. In some embodiments, a recoil velocity of said excitation electromagnetic energy is about equal to said relative velocity. In some embodiments, said recoil velocity is defined as v=hk/m where k=2π/λ is the wavenumber of said excitation electromagnetic energy. In some embodiments, a characteristic trap frequency of said first state potential is substantially equal to a characteristic trap frequency of said second state potential. In some embodiments, a characteristic length is defined as

$${a}_{ho} = \sqrt{\frac{ℏ}{m ω}} ,$$

where ω is said characteristic trap frequency, and a temporal duration of said excitation electromagnetic energy is short relative to a parameter defined as said characteristic trap length divided by said recoil velocity. In some embodiments, said temporal duration is shorter than said parameter by a factor of three. In some embodiments, said temporal duration is shorter than said parameter by a factor of ten.

In some embodiments, said trapping optical source is configured to: trap said first state and said second state with a trapping optical excitation, wherein said trapping optical excitation is tuned such that said first state and said second state have substantially equal polarizabilities; and apply a potential gradient, and wherein translating said excite state potential comprises changing said potential gradient in time. In some embodiments, said potential gradient is linear in a spatial dimension. In some embodiments, said potential is an electric potential or a magnetic potential.

In some embodiments, said trapping optical source is configured to: translate said second state potential, wherein said first state potential is substantially stationary, and wherein said translating is performed substantially without altering said first state potential. In some embodiments, said trapping optical source is configured to: translate said first state potential, wherein said second state potential is substantially stationary, and wherein said translating is performed substantially without altering said second state potential. In some embodiments, said plurality of atoms are qubits. In some embodiments, said plurality of atoms comprises neutral atoms. In some embodiments, said plurality of atoms comprises two the system comprises a portion of a non-classical computer. In some embodiments, said non-classical computer is a quantum computer.

In some embodiments, the first state is a lower state, and the second state is an upper state. In some embodiments, the lower state is a ground state, and the upper sate is an excited state. In some embodiments, the first state and the second state are electronic states. In some embodiments, the transitioning is an absorption. In some embodiments, the transitioning is an emission.

In another aspect, the present disclosure provides a method for transitioning an atom from a first state to a second state with a single photon, wherein a motional state of the atom is preserved. The method may comprise: (a) providing a plurality of atoms in a plurality of spatially distinct optical trapping sites; (b) generating a translating second state potential in a spatial dimension across a confining potential energy landscape of the first state of the atom of the plurality of atoms; and (c) exiting the atom with an excitation electromagnetic energy, wherein a temporal duration of the excitation electromagnetic energy is short relative to a characteristic length of the confining potential energy landscape.

In some embodiments, the plurality of spatially distinct optical trapping sites is generated by a trapping optical source. In some embodiments, the trapping optical source comprises at least two optical sources. In some embodiments, a first trapping optical source is configured to trap the atom in the first state, and wherein a second trapping optical source is configured to trap the atom in the second state. In some embodiments, a trapping wavelength of the first trapping optical source is substantially equal to a trapping wavelength of the second trapping optical source. In some embodiments, a trapping wavelength of the first trapping optical source and a trapping wavelength of the second trapping optical source are selected such that a polarizability of the first state and a polarizability of the second state are substantially equal. In some embodiments, the translating excitation potential comprises a linear potential gradient, and wherein (b) comprises changing the linear potential gradient in time.

In some embodiments, a wavelength of a trapping optical source for the plurality of spatially distinct optical trapping sites is selected such that the second state potential of the atom of the plurality of atoms experiences substantially no optical dipole force.

In some embodiments, the translating excitation potential comprises velocity v=hk/n, where k=2π/λ is the wavenumber of an optical source configured to generate the translating excitation potential.

In some embodiments, the plurality of atoms are qubits. In some embodiments, the plurality of atoms comprises neutral atoms. In some embodiments, the plurality of atoms comprises two valence electron atoms. In some embodiments, the atom is Ytterbium. In some embodiments, the method further comprises performing a non-classical computation. In some embodiments, the non-classical computation is a quantum computation.

In some embodiments, the first state is a lower state, and the second state is an upper state. In some embodiments, the lower state is a ground state, and the upper sate is an excited state. In some embodiments, the first state and the second state are electronic states. In some embodiments, the transitioning is an absorption. In some embodiments, the transitioning is an emission.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates a flowchart of a method for preserving a motional state of an atom during interaction with a photon, in accordance with some embodiments.

FIG. 2 illustrates an example of an energetic landscape related to methods and systems of the present disclosure, in accordance with some embodiments.

FIG. 3 illustrates a flowchart of a method for exciting an atom from a ground electronic state to an excited electronic state with a single photon, wherein a motional state of the atom is preserved, in accordance with some embodiments.

FIG. 4 illustrates a plurality of spatially distinct optical traps, in accordance with some embodiments.

FIG. 5 illustrates a schematic of a system for preserving a motional state of an atom when said atom is excited between states, in accordance with some embodiments.

FIG. 6 illustrates a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than.” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein, like characters refer to like elements.

The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

### Methods and Systems for Doppler-Free Single-Photon Excitation of Atoms Via Moving Potentials

Aspects of the present disclosure provide methods and systems to change quantum states of atoms (e.g., exciting an atom from its ground to excited electronic state with a photon, exciting from a first electronic state to a higher electronic state, etc.) while preserving the motional state of the atom. Aspects of the present disclosure preserve the motional state of the atom at least in part by canceling the imparted momentum of the photon.

These methods may improve upon methods which address changes in motional state by operating in the resolved sideband regime. For example, to operate in the resolved sideband regime, a trapping potential with a relatively high trap depth may be chosen such that the energy resolution of the laser is higher than the difference between motional quantum states. When an experiment operates in the resolved sideband limit, it may be possible to excite a specific transition to a specific motional state. The resolved-sideband condition may be expressed as ω>>Γ, where ω is the trap frequency and Γ is the decay rate of the atomic excited state. Then, the transition is driven with a Rabi frequency Ω<<ω, so that the transition sidebands corresponding to different numbers of motional quanta are spectroscopically resolved. This may allow the excitation of a specific transition |g,n>→|e,n′> (where g is the ground state, e is the excited state, and n and n′ are motional states) by energy resolution alone, even though the matrix elements between the ground state and all possible excited motional states are nonzero due to the factor e^{ikx} (representing the motional quanta carried by the photon). An example of an experiment operating in the resolved-sideband limit is provided by, for example, X. Zhang et al., Phys. Rev. Lett. 129, 113202 (2022), which is incorporated by reference herein in its entirety for all purposes. The Zhang reference may describe a trapping potential which allows resolution of a motional sideband spectrum of Ytterbium atoms in an optical lattice. These atoms are deep in the resolved sideband regime due to the very narrow clock transition.

However, operating in a resolved sideband limit may have various drawbacks. For example, a trapping potential and an atomic transition may be chosen specifically to allow for sideband resolution. Certain atomic transitions may not facilitate operating in this limit. For those that do facilitate operating in this limit, a trap depth may be required to be relatively deep such that the energy gap between motional states is comparatively large. Further, the linewidth of the laser may be required to be relatively narrow in order to resolve the motional states. A narrow linewidth may require operations on the states to be relatively slow due to the uncertainty principle. If ΔE is narrower, then Δt would be slower. Operations in the resolved sideband limit may be slow, on the order of microseconds, which may be result in inconveniently slow operations in terms of computation time or preserving coherence.

Aspects of the present disclosure improve upon methods operating in a resolved sideband limit at least by canceling the imparted momentum of the photon by translating the array of optical traps. Aspects of the present disclosure provide a method to excite an atom from its ground to excited electronic state with a single photon while preserving the motional state of the atom at least in part by canceling the imparted momentum of the photon.

The present disclosure provides methods and systems for preserving a motional state of an atom during interaction with a photon. The interaction may comprise an excitation from a ground state to an excited state. The excitation may comprise an excitation from a first state to a second state which is lower than the first state. The excitation may comprise an excitation from a first state to a second state which is higher than the first state.

In an example, provided herein is a method for preserving a motional state of an atom when the atom is excited from a first state to a second state. The method may comprise providing an atom in a ground state. The atom may be trapped at a trapping site of a plurality of spatially distinct optical trapping sites by a ground state potential. The method may comprise translating an excited state potential in a spatial dimension relative to the ground state potential. The method may comprise exciting the atom to the excited state with an excitation electromagnetic energy. The relative velocity of the excited state potential relative to the ground state potential may substantially counteract a momentum imparted by an exciting photon of the excitation electromagnetic energy.

In an example, provided herein is a system for preserving a motional state of an atom when the atom is excited from a first state to a second state. The system may comprise an atom in a ground state. The atom may be trapped at a trapping site of a plurality of spatially distinct optical trapping sites by a ground state potential. The system may comprise an excited state potential which is operable to be translated in a spatial dimension relative to the ground state potential. The system may comprise an excitation electromagnetic energy which is operable to excite the atom to the excited state. The relative velocity of the excited state potential relative to the ground state potential may substantially counteract a momentum imparted by an exciting photon of the excitation electromagnetic energy.

In some cases, the technique may comprise various tunable components. In some cases, one component may be the choice of laser wavelength(s) that create trapping potentials for the ground and excited state atoms. The choice of the trapping potentials may be useful to provide trap light which allows for independent control of the second and lower states of the transition. In some cases, one component may be a translation applied to the excited state potential. It may be useful to affect a translation which has a substantially uniform effect on the excited state. If the translation is uniform, then the momentum imparted by moving either trap state relative to the other will similarly affect all trapped atoms. In some cases, one component may be the timing of the excitation laser pulse. It may be advantageous for a moving potential to be moved during a temporal window when the excitation from the first state to the second state with the photon occurs.

### Trapping

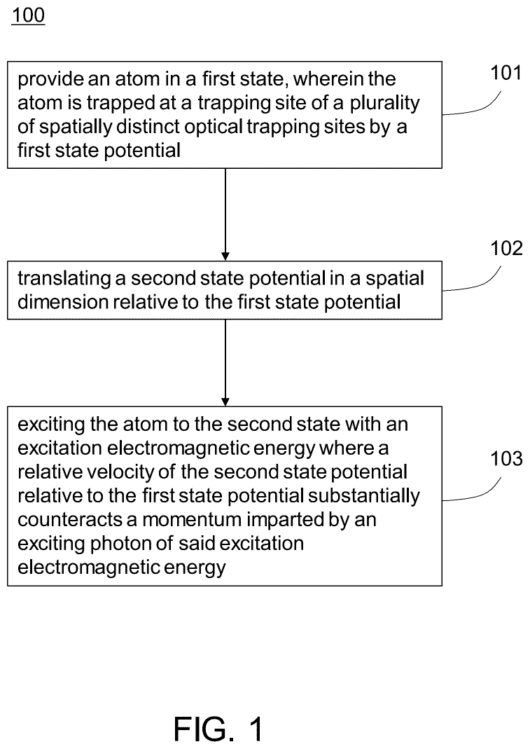

FIG. 1 illustrates a flowchart of a method for preserving a motional state of an atom during interaction with a photon. At an operation 101 the method 100 may comprise providing an atom in a first (e.g., a lower state, a ground state, etc.) state. The atom may be trapped at a trapping a trapping site of a plurality of spatially distinct optical trapping sites by a first (e.g., a lower state, a ground state, etc.) state potential. While various examples throughout the disclosure use an excited and a ground state, the methods and systems disclosed herein may be similarly applicable to any two states. For example, the transition may be from a lower state to an upper state. However, the transition may be a stimulated emission from an upper state to a lower sate. Similarly, various examples throughout the disclosure are directed to electronic states, the methods and systems disclosed herein may be similarly applicable other states where state selectivity to within a motional quanta imparted by a photon is of interest.

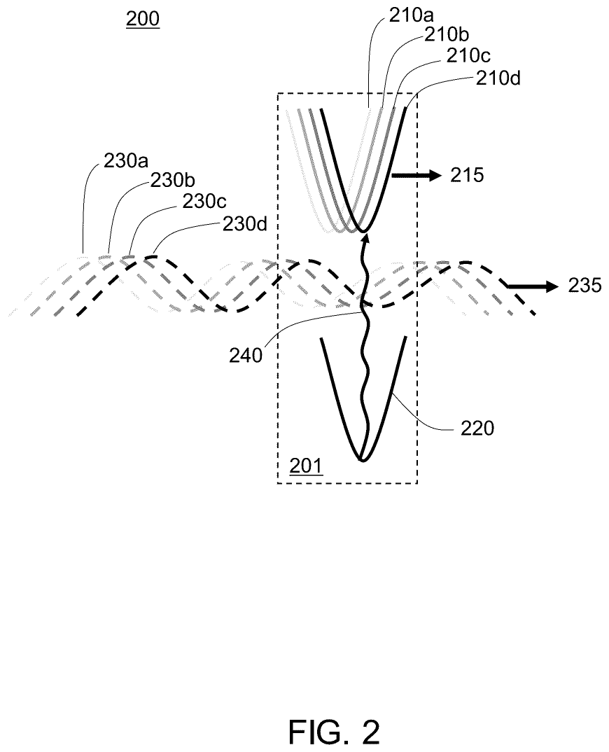

FIG. 2 illustrates an example of an energetic landscape 200 related to methods and systems of the present disclosure, in accordance with some embodiments. The landscape may comprise a first trapping potential 210 and a second trapping potential 220. In the illustrated example, the first trapping potential 210 is an upper state and a second trapping potential 220 is a lower state. The upper state and the lower state may be separated by an energy gap. The first and second trapping potentials may relate to the trapping potentials of a trapping site 201 of a plurality of spatially distinct optical trapping sites.

The choice of the trapping potentials may be useful to provide trap light which allows for independent control of the upper and lower states of the transition. For example, independent control may comprise choosing a trap laser or trap lasers such that the trapping light for the upper state does not affect the trapping light for the lower state or vice versa. For example, at an operation 101, the ground state may be confined by a trap laser at a wavelength such that the excited state potential feels no, or substantially no, optical dipole force, and therefore no, or substantially no, potential from the trap laser. Similarly, the excited state may be confined by a trap with a wavelength chosen so that the ground state feels no, or substantially no, optical dipole force and therefore no, or substantially no, potential from that laser. In this situation, the potential energy landscapes for the ground and excited states may be chosen independently.

In some cases, the intensities of the trapping laser(s) may be chosen so that the trap frequency ω for the ground and excited states are equal, or substantially equal. This may correspond to different optical intensities, since the polarizabilities of the ground and excited states in their respective trapping wavelengths may be different.

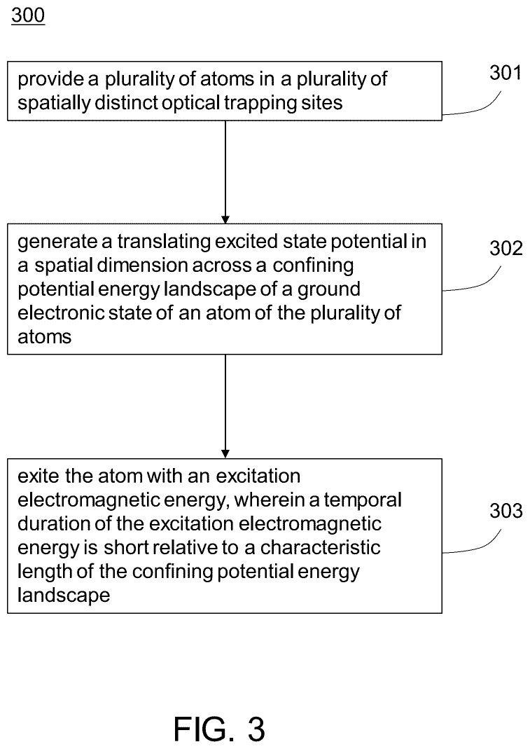

FIG. 3 illustrates a method 300 for exciting an atom from a ground electronic state to an excited electronic state with a single photon, wherein a motional state of the atom is preserved. At an operation 301, the method 300 may comprise providing a plurality of atoms in a plurality of spatially distinct optical trapping sites. Operation 301 may comprise one or more sub-operations. For example, operation 301 may comprise providing an atom in a ground state, wherein the atom is trapped at a trapping site of the plurality of spatially distinct optical trapping sites by a ground state potential as described herein above with respect to operation 101 of the method 100.

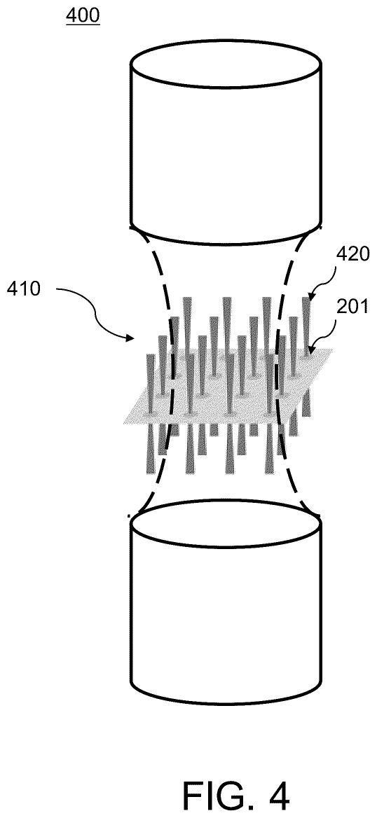

Optical Traps—FIG. 4 illustrates a plurality of spatially distinct optical traps 400, in accordance with some embodiments. Systems and methods of the present disclosure provide a plurality of spatially distinct optical traps 410. The plurality of optical traps may comprise a plurality of optical trapping sites, such as optical trapping site 201. The plurality of optical trapping sites may be spatially distinct. In some cases, the plurality of spatially distinct optical trapping sites comprises one or more trapping potentials, e.g., a first trapping potential 210 and a second trapping potential 220. In some cases, a first state is trapped by a first trapping potential and a second state is trapped by a second trapping potentials.

The system may comprise one or more trapping systems. The trapping systems may comprise one or more optical trapping units. The optical trapping systems may comprise any optical trapping unit described herein. For example, the one or more trapping units may comprise one or more trapping optical sources of the present disclosure. FIG. 4 illustrates a spatial pattern 420 in two dimensions of a trapping optical source. In some cases, the spatial pattern comprises attractive traps. In some cases, the spatial patter comprises repulsive traps.

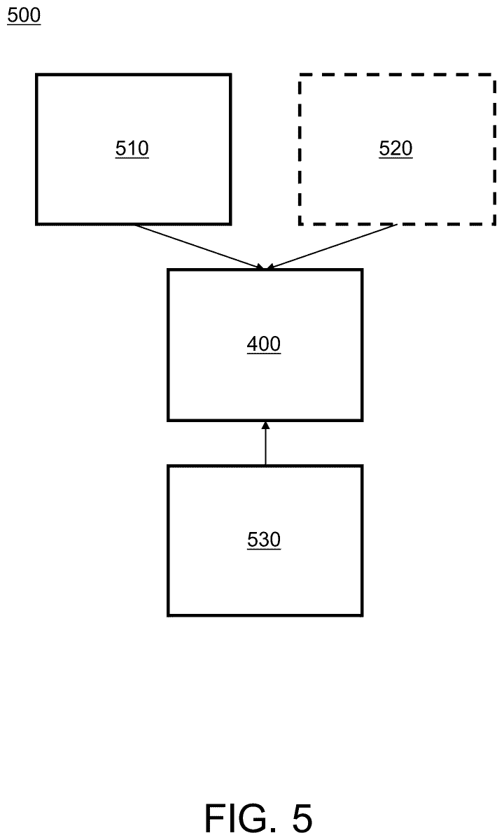

In some cases, the plurality of spatially distinct optical trapping sites is generated by a trapping optical source, such as those described herein with respect to FIG. 5. In some cases, the trapping optical source comprises at least two optical sources. In some cases, a first trapping optical source is configured to trap the atom in a first (e.g., a lower state, a ground state, etc.) electronic state, and a second trapping optical source is configured to trap the atom in the second (e.g., an upper state, an excited state, etc.) state. In some cases, a trapping wavelength of the first trapping optical source is different than a trapping wavelength of the second trapping optical source. In some cases, the second (e.g., an upper state, an excited state, etc.) state potential feels substantially no optical dipole force from said first trapping optical source. In some cases, the first (e.g., a lower state, a ground state, etc.) state potential feels substantially no optical dipole force from the second trapping optical source.

In some examples, the optical traps may be formed by tightly focused light (tweezers) or by standing-wave lattices, or by imaged masks or gratings. Optical trapping may additionally include various methods where atoms are cooled with optical illumination, e.g., a laser, and a spatially varying magnetic field to create a trap. Such optical traps may be called magneto-optical traps (MOTs).

In some cases, the plurality of spatially distinct optical traps comprises a 1D, 2D, or 3D optical trap. In some examples, the arrays may be linear, two-dimensional, three-dimensional, or may involve synthetic dimensions. A synthetic dimension may include, for example, dimensions consisting of internal atomic states or motional states. The plurality of spatially distinct optical traps may comprise single or multiple reservoir regions. In some examples, the arrays may be of regular or irregular or quasi-regular geometry.

Optical tweezers—In some cases, the plurality of spatially distinct optical traps comprises optical tweezers. The optical trapping sites may comprise one or more optical tweezers. Optical tweezers may comprise one or more focused laser beams to provide an attractive or repulsive force to hold or move the one or more atoms. The beam waist of the focused laser beams may comprise a strong electric field gradient. The atoms may be attracted or repelled along the electric field gradient to the center of the laser beam, which may contain the strongest electric field. The optical trapping sites may comprise one or more optical tweezer sites of one or more optical arrays of tweezers. The optical trapping sites may comprise one or more optical tweezer sites of one or more one-dimensional (1D) optical arrays of tweezers, two-dimensional (2D) optical arrays of tweezers, or three-dimensional (3D) optical arrays of tweezers. In some cases, the methods and systems described herein may be applied similarly to optical lattices. Optical tweezers may be useful in moving atoms or arrays of atoms.

Sites—The optical trapping system may be configured to generate a plurality of optical trapping sites. The optical trapping system may be configured to generate a plurality of spatially distinct optical trapping sites. Each optical trapping system may comprise any number of sites disclosed herein. Each optical trapping system may comprise any number of trapped atoms disclosed herein.

For instance, each optical trapping system may be configured to generate at least about 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more optical trapping sites. Each optical trapping system may be configured to generate at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, or fewer optical trapping sites. The optical trapping system(s) may be configured to trap a number of optical trapping sites that is within a range defined by any two of the preceding values.

Each optical trapping system may be configured to trap a plurality of atoms. For instance, each optical trapping system may be configured to trap a total number of atoms in the plurality of optical trapping sites of at least about 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more atoms. For example, the optical trapping system(s) may be configured to trap a total number of atoms in the plurality of optical trapping sites of at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, or fewer atoms. The optical trapping system(s) may be configured to trap a number of atoms that is within a range defined by any two of the preceding values.

Trap Electromagnetic Energy—In some cases, method and systems disclosed herein may be configured to form a plurality of optical trapping sites using a trap electromagnetic energy (e.g., a “trap excitation” herein). The trap excitation may be generated by a trapping optical source of the present disclosure.

The trap excitation may comprise an optical excitation, such as in a magneto-optical trap, an optical tweezer, etc. In some cases, the trap excitation is delivered by one or more optical trapping systems as disclosed herein. In some cases, each optical trapping system comprises its own trap excitation (e.g., trap wavelength, trap power, trap focus, number of spots, etc.). In some cases, a single trap excitation may be split into multiple arrays in order to form a plurality of arrays of traps with similar characteristics.

In some examples, using separate lasers or optics to form the first (e.g., a lower state, a ground state, etc.) trapping potential as compared to the lasers or optics that may be used to form the second (e.g., a upper state, a excited state, etc.) trapping potential, for example) may be useful for one or more reasons. In one example, different laser wavelengths, trap geometries (e.g., tweezer-spot sizes or spacings), or methods for generating the different arrays (e.g., acousto-optic deflectors (AODs), spatial light modulators (SLMs), digital mirror devices (DMDs), micro-lens arrays, diffraction gratings, standing wave lattices, imaged structures, or other) can be used to create the upper and lower trapping potentials. Therefore, the properties (trap depths, differential polarizabilities on relevant atomic transitions, trap spacing, trap oscillation frequency, etc.) of each array can be optimized for its specific role. For example, using separate lasers or optics to form each potential may allow for differential polarizabilities on each the upper and the lower electronic state.

The optical trapping system(s) may comprise one or more light sources configured to emit light to generate the plurality of optical trapping sites as described herein. For instance, the optical trapping system(s) may comprise a single light source. In some cases, the optical trapping system(s) may comprise any number of light sources, such as at least about 1, 2, 3, 4, 5, 6, 7, 8, 9, 10, or more light sources or at most about 10, 9, 8, 7, 6, 5, 4, 3, 2, or 1 light sources. The light sources may comprise one or more lasers.

The light sources may be configured to direct light to one or more optical modulators (OMs) configured to generate the plurality of optical trapping sites. For instance, the optical trapping unit may comprise an OM configured to generate the plurality of optical trapping sites. In some cases, the optical trapping unit may comprise any number of OMs, such as at least about 1, 2, 3, 4, 5, 6, 7, 8, 9, 10, or more OMs or at most about 10, 9, 8, 7, 6, 5, 4, 3, 2, or 1 OMs. The OMs may comprise one or more digital micromirror devices (DMDs). The OMs may comprise one or more liquid crystal devices, such as one or more liquid crystal on silicon (LCoS) devices. The OMs may comprise one or more spatial light modulators (SLMs). The OMs may comprise one or more acousto-optic deflectors (AODs) or acousto-optic modulators (AOMs). The OMs may comprise one or more electro-optic deflectors (EODs) or electro-optic modulators (EOMs).

The OM may be optically coupled to one or more optical element to generate a regular array of optical trapping sites. The optical elements may comprise lenses or microscope objectives configured to re-direct light from the OMs to form a regular rectangular grid of optical trapping sites.

For instance, the OM may comprise an SLM, DMD, or LCoS device. The SLM, DMD, or LCoS device may be imaged onto the back focal plane of the microscope objectives. This may allow for the generation of an arbitrary configuration of optical trapping sites in two or three dimensions.

In some cases, the trap excitation for each optical trapping system comprises one or more wavelengths. The one or more wavelengths may comprise: 423 nm, 460 nm, 485 nm, 532 nm, 780 nm, or combinations thereof. The trapping excitation may be tuned slightly off of a wavelength of the transition electromagnetic energy. For example, if the excitation electromagnetic energy comprises a 399 nm ¹P₁ transition followed by the 556 nm ³P₁ narrow-line transition, then the trap excitation may be slightly off of 399 nm or 556 nm or both. The trap excitation for each optical trapping system may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm 580 nm 570 nm, 560 nm, 550 nm, 540 nm, 530 nm, 520 nm 510 nm, 500 nm, 490 nm, 480 nm 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

Atoms Systems and methods of the present disclosure may be applied to any atomic system that may be cooled and trapped. In some cases, the plurality of atoms comprises neutral atoms. In some cases, the plurality of atoms comprises a Group II element. In some cases, the plurality of atoms comprises Scandium. In some cases, the plurality of atoms comprises a Group II-like element. In some cases, the plurality of atoms an atom with two-valence electrons. In some cases, the plurality of atoms comprises Ytterbium. In some cases, the plurality of atoms are qubits.

The optical trapping system may be configured to trap neutral atoms. In some cases, the optical trapping system may trap alkaline earth or an alkaline earth-like atom. In some cases, an alkaline earth-like atom comprises two valence electrons. In some cases, an alkaline earth or an alkaline earth-like atom comprises strontium or ytterbium.

One or more atoms may comprise alkali atoms. One or more atoms may comprise lithium (Li) atoms, sodium (Na) atoms, potassium (K) atoms, rubidium (Rb) atoms, or cesium (Cs) atoms. One or more atoms may comprise lithium-6 atoms, lithium-7 atoms, sodium-23 atoms, potassium-39 atoms, potassium-40 atoms, potassium-41 atoms, rubidium-85 atoms, rubidium-87 atoms, or caesium-133 atoms. One or more atoms may comprise alkaline earth atoms. One or more atoms may comprise beryllium (Be) atoms, magnesium (Mg) atoms, calcium (Ca) atoms, strontium (Sr) atoms, or barium (Ba) atoms. One or more atoms may comprise beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133, barium-134 atoms, barium-135 atoms, barium-136 atoms, barium-137 atoms, or barium-138 atoms. One or more atoms may comprise rare earth atoms. One or more atoms may comprise scandium (Sc) atoms, yttrium (Y) atoms, lanthanum (La) atoms, cerium (Ce) atoms, praseodymium (Pr) atoms, neodymium (Nd) atoms, samarium (Sm) atoms, europium (Eu) atoms, gadolinium (Gd) atoms, terbium (Tb) atoms, dysprosium (Dy) atoms, holmium (Ho) atoms, erbium (Er) atoms, thulium (Tm) atoms, ytterbium (Yb) atoms, or lutetium (Lu) atoms. One or more atoms may comprise scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms.

### Moving Trapping Potential

Returning to FIG. 1, FIG. 1 illustrates a flowchart of a method for preserving a motional state of an atom during interaction with a photon. At an operation 102 the method 100 may comprise translating a second (e.g., an upper state, an excited state, etc.) state potential in a spatial dimension relative to the first (e.g., a lower state, a ground state, etc.) state potential. In some cases, translating the excited state potential in a spatial dimension relative to said ground state potential comprises translating the second (e.g., an upper state, an excited state, etc.) state potential. In some cases, translating the excited state potential in a spatial dimension relative to said ground state potential comprises translating the first (e.g., a lower state, a ground state, etc.) state potential. In some cases, translating the excited state potential in a spatial dimension relative to said ground state potential comprises translating the upper state to a greater or lesser extent than the lower state.

Returning to FIG. 2, FIG. 2 illustrates an example of an energetic landscape 200 related to methods and systems of the present disclosure, in accordance with some embodiments. The landscape may comprise a first trapping potential 210 and a second trapping potential 220. In the illustrated example, the first trapping potential 210 is an upper state and a second trapping potential 220 is a lower state. The upper state and the lower state may be separated by an energy gap. The first and second trapping potentials may relate to the trapping potentials one of a plurality of spatially distinct optical trapping sites. In some cases, operation 102 is performed substantially without altering a trapping potential of either the second (e.g., an upper state, an excited state, etc.) electronic state or the first (e.g., a lower state, a ground state, etc.).

As shown in the illustrated example, translating the excited state potential in a spatial dimension relative to said ground state potential may comprise translating the second (e.g., an upper state, an excited state, etc.) state potential. FIG. 2 illustrates various potentials 210a, 210b, 210c, and 210d representing first trapping potential 210 at various time points increasing from 210a to 210b to 210c to 210d. Arrow 215 shows a direction of propagation in a spatial direction of the excited state potential. As shown in the illustrated example, second trapping potential 220 may remain relatively stationary.

In some cases, operation 102 is comprises translating the second (e.g., an upper state, an excited state, etc.) state potential. The first (e.g., a lower state, a ground state, etc.) state potential may be substantially stationary. The translating may be performed substantially without altering the first (e.g., a lower state, a ground state, etc.) state potential. For example, the substantially without altering may mean translation of the first (e.g., a lower state, a ground state, etc.) state potentially by less than one motional quanta.

In some cases, operation 102 is comprises translating the first (e.g., a lower state, a ground state, etc.) state potential. The second (e.g., an upper state, an excited state, etc.) state potential may be substantially stationary. The translating may be performed substantially without altering the second (e.g., an upper state, an excited state, etc.) state potential. For example, the substantially without altering may mean translation of the second (e.g., an upper state, an excited state, etc.) state potentially by less than one motional quanta.

In some cases, operation 102 is comprises trapping the ground electronic state and the excited electronic state with a trapping optical excitation. In some cases, the trapping optical excitation is tuned such that said ground electronic state and said excited electronic state have substantially equal polarizabilities. In some cases, operation 102 also comprises and applying a potential gradient and changing said potential gradient in time. In some cases, the potential gradient is linear in a spatial dimension. In some cases, the potential is an electric potential or a magnetic potential.

In some cases, operation 102 is comprises translating a magnetic field or providing a magnetic field gradient. In some cases, the second (e.g., an upper state, an excited state, etc.) state potential and the first (e.g., a lower state, a ground state, etc.) state potential exhibit a differential sensitivity to said magnetic field or said magnetic field gradient. In some cases, the second (e.g., an upper state, an excited state, etc.) is more sensitive to said magnetic field or said magnetic field gradient than said first (e.g., a lower state, a ground state, etc.) state potential. In some cases, the first (e.g., a lower state, a ground state, etc.) is more sensitive to said magnetic field or said magnetic field gradient than the second (e.g., an upper state, an excited state, etc.) state potential.

Scanning Velocity—For example, at an operation 210, the second (e.g., an upper state, a excited state, etc.) state potential may be scanned across the position of the first (e.g., a lower state, a ground state, etc.) state potential at velocity v=hk/m where k=2π/λ is substantially equal to the wavenumber of the excitation laser. The wavenumber of the excitation laser may not be equal to the trapping laser(s). For example, these parameters may be independently tunable. The velocity may be at least about 1 meter per second (m/s), 2 m/s, 3 m/s, 4 m/s, 5 m/s, 6 m/s, 7 m/s, 8 m/s, 9 m/s, 10 m/s, 20 m/s, 30 m/s, 40 m/s, or more. The velocity may be at most about 40 m/s, 30 m/s, 20 m/s, 10 m/s, 9 m/s, 8 m/s, 7 m/s, 6 m/s, 5 m/s, 4 m/s, 3 m/s, 2 m/s, 1 m/s, or less.

The second state may be scanned by the one or more trapping optical sources as described elsewhere herein. The one or more trapping optical sources may comprise one or more light sources. The one or more light sources may be configured to direct light to one or more optical modulators (OMs) configured to generate the plurality of optical trapping sites. In some cases, the one or more optical modulators may be configured to direct the light used to generate the plurality of spatially distinct optical traps. For instance, the optical trapping unit may comprise an OM configured to translate a potential of the plurality of spatially distinct optical traps. In some cases, the optical trapping unit may comprise any number of OMs, such as at least about 1, 2, 3, 4, 5, 6, 7, 8, 9, 10, or more OMs or at most about 10, 9, 8, 7, 6, 5, 4, 3, 2, or 1 OMs.

The OMs may comprise one or more digital micromirror devices (DMDs). The OMs may comprise one or more liquid crystal devices, such as one or more liquid crystal on silicon (LCoS) devices. The OMs may comprise one or more spatial light modulators (SLMs). The OMs may comprise one or more acousto-optic deflectors (AODs) or acousto-optic modulators (AOMs). The OMs may comprise one or more electro-optic deflectors (EODs) or electro-optic modulators (EOMs).

In some cases, translating a potential comprises moving a mirror. Moving a mirror may comprise manual translation, use of a piezo, use of a galvo (e.g., a magnetically actuated mirror), etc. In some cases, translating a potential comprises chirping a frequency of an AOD to move a diffraction pattern from the AOD which may move the beam. In some cases, translating a potential comprises changing the parameters of the SLM to generate a projected pattern in a new position.

Returning to FIG. 3, FIG. 3 illustrates a method 300 for exciting an atom from a ground electronic state to an excited electronic state with a single photon, wherein a motional state of the atom is preserved. At an operation 302, the method 300 may comprise generating a translating excited state potential in a spatial dimension across a confining potential energy landscape of the ground electronic state of the atom of the plurality of atoms. Operation 302 may comprise one or more sub-operations. For example, operation 302 may comprise translating an excited state potential in a spatial dimension relative to a ground state potential as described herein above with respect to operation 102 of the method 100.

### Optical Excitation

Returning to FIG. 1, FIG. 1 illustrates a flowchart of a method for preserving a motional state of an atom during interaction with a photon. At an operation 103 the method 100 may comprise exciting the atom to a second (e.g., an upper state, an excited state, etc.) electronic state with an excitation electromagnetic energy. In some cases, a relative velocity of the second (e.g., an upper state, an excited state, etc.) state potential relative to the first (e.g., a lower state, a ground state, etc.) state potential substantially counteracts a momentum imparted by an exciting photon of the excitation electromagnetic energy.

The wavenumber (similarly, wavelength) of the excitation laser and the relative scanning velocity of the upper state relative to the lower state may be selected such that they are substantially equal. Substantially equal to may comprise equal within plus or minus one motional quanta of the trap state. For example, at an operation 210, the second (e.g., an upper state, an excited state, etc.) state potential may be scanned across the position of the first (e.g., a lower state, a ground state, etc.) state potential at velocity v=hk/m where k=2π/λ is the wavenumber of the excitation laser. The parameter v may be the recoil velocity of the excitation laser. The recoil velocity may be equal to the velocity that would be imparted to a stationary atom initially in the ground state if it absorbed a photon from the excitation laser, transferring it to the excited state.

Returning to FIG. 2, FIG. 2 illustrates an example of an energetic landscape 200 related to methods and systems of the present disclosure, in accordance with some embodiments. The landscape may comprise a first trapping potential 210 and a second trapping potential 220. In the illustrated example, the first trapping potential 210 is an upper state and a second trapping potential 220 is a lower state. The upper state and the lower state may be separated by an energy gap. The first and second trapping potentials may relate to the trapping potentials of one of a plurality of spatially distinct optical trapping sites.

Also illustrated in FIG. 2 is an excitation electromagnetic energy 240. The excitation electromagnetic energy may comprise a wavelength about equal to the energy gap between the upper and the lower state. The excitation electromagnetic energy may be also thought of as a traveling wave. A set of traveling waves representing excitation electromagnetic energy 240 are shown as 230a, 230b, 230c, and 230d representing excitation electromagnetic energy 240 at various time points increasing from 230a to 230b to 230c to 230d. Arrow 235 shows a direction of propagation of a wavefront of the traveling wave. The photon of excitation electromagnetic energy 240 may carry with it a momentum. The relative velocity of the translating potentials may also carry with it a momentum. These momenta may counteract one another under certain conditions.

In some cases, a modification of the transition probabilities versus the motional state of the atom is provided by the method. The result of the trap motion may be that the quantum eigenstates of motion of the second (e.g., an upper state, an excited state, etc.) state potential are modified.

For illustrative purposes, a ground state and an excited state are shown. For example, let us represent the ground-state wavefunctions as φ_{g,n}(x,y)=φₙ(x)e^{-xE}^{ₙ}^{t} where φₙ are the trap eigenstates enumerated by motional quantum number n. Then, the excited-state wavefunctions may be written as

$${ψ}_{e , n} ( x , t ) = {ϕ}_{n} ( x - vt ) {e}^{- i ( {E}_{n} + \frac{{mv}^{2}}{2} ) t} {e}^{ikx} .$$

When computing the transition matrix element, the factor e^{ikx} in this moving eigenstate cancels the identical factor e^{ikx} in the traveling-wave laser. As a result, the orthogonality between motional states is restored.

Timing—In some cases, a temporal duration of the excitation electromagnetic energy is short relative to a characteristic length of the ground state potential. The above relation shows that the duration of the of the pulse of the excitation laser may be short compared to t₀=aₕₒ/v, where

$${a}_{ho} = \sqrt{\frac{ℏ}{m ω}}$$

is the characteristic length of the confining potential. If the laser pulse exciting the atom is applied during this time, then the atom may be excited from a single quantum state of motion in the ground electronic state potential to a single quantum state of motion in the excited state potential very quickly, without regard to (or with less sensitivity to) the relative magnitude of ω and Γ, where w is the trap frequency and Γ is the decay rate of the atomic excited state.

At an operation 103, the excitation laser may be applied to an atom in a pulse. In some cases, the duration of the pulse of the excitation laser may be short compared to t₀=aₕₒ/v, where

$${a}_{ho} = \sqrt{\frac{ℏ}{m ω}}$$

is the characteristic length of the confining potential.

Returning to FIG. 3, FIG. 3 illustrates a method 300 for exciting an atom from a ground electronic state to an excited electronic state with a single photon, wherein a motional state of the atom is preserved. At an operation 303, the method 300 may comprise exiting the atom with an excitation electromagnetic energy. The temporal duration of the excitation electromagnetic energy may be short relative to a characteristic length of the confining potential energy landscape. Operation 303 may comprise one or more sub-operations or additional operations. For example, operation 303 may further comprise an example variation or embodiment of operation 103 of the method 100.

Recoil Velocity—In some cases, a recoil velocity of the excitation electromagnetic energy is about equal to the relative velocity. In some cases, the recoil velocity is defined as v=hk/m, where k=2π/λ is the wavenumber of the excitation electromagnetic energy. For example, the second (e.g., an upper state, an excited state, etc.) state potential may be scanned across the position of the first (e.g., a lower state, a ground state, etc.) state potential at velocity v=hk/m where k=2π/λ is substantially equal to the wavenumber of the excitation laser. The parameter v may be the recoil velocity of the excitation laser. The recoil velocity may be equal to the velocity that would be imparted to a stationary atom initially in the ground state if it absorbed a photon from the excitation laser, transferring it to the excited state. The recoil velocity may be at least about 1 meter per second (m/s), 2 m/s, 3 m/s, 4 m/s, 5 m/s, 6 m/s, 7 m/s, 8 m/s, 9 m/s, 10 m/s, 20 m/s, 30 m/s, 40 m/s, or more. The velocity may be at most about 40 m/s, 30 m/s, 20 m/s, 10 m/s, 9 m/s, 8 m/s, 7 m/s, 6 m/s, 5 m/s, 4 m/s, 3 m/s, 2 m/s, 1 m/s, or less.

Characteristic Length—In some cases, the characteristic length of the ground and excited (e.g., upper and lower) states may be identical, or substantially identical. In some cases, a characteristic trap frequency of the ground state potential is substantially equal to a characteristic trap frequency of the excited state potential. For example, the characteristic lengths may be substantially identical the upper and lower state traps have the same value of w. In some cases, a characteristic trap frequency of the first (e.g., a lower state, a ground state, etc.) state potential is substantially equal to a characteristic trap frequency of the second (e.g., an upper state, an excited state, etc.) state potential. In some cases, the characteristic length is defined as

$${a}_{ho} = \sqrt{\frac{ℏ}{m ω}} ,$$

where ω is the characteristic trap frequency.

The characteristic length may be on the order of 100's of nanometers (nm). The characteristic length may be at least about 100 nm, 200 nm, 300 nm, 400 nm, 500 nm, 600 nm, 700 nm, 800 nm, 900 nm, 1000 nm or more. The characteristic length may be at most about 1000 nm, 900 nm, 800 nm, 700 nm, 600 nm, 500 nm, 400 nm, 3X) nm, 200 nm, 100 nm, or less.

Parameter—In some cases, a temporal duration of the excitation electromagnetic energy is short relative to a parameter defined as said characteristic trap length divided by said recoil velocity. In some cases, the temporal duration is shorter than the parameter by a factor of three. In some case, the temporal duration is shorter than the parameter by a factor of ten. The temporal duration may be shorter than the parameter by a factor at least about 1, 2, 3, 4, 5, 6, 7, 8, 9, 10, 20, 30, 40, 50, 100, or more.

### System for Preserving Motional State

FIG. 5 illustrates a schematic of system 500 for preserving a motional state of an atom when said atom is excited between electronic states. The system may comprise a plurality of spatially distinct optical trapping sites 400. The plurality of spatially distinct optical trapping sites may comprise an atom in a site 201 of said plurality of spatially distinct optical trapping sites. The atom may be trapped by a lower state potential 220.

The system may comprise a trapping optical source 510. The trapping optical source may be operable to translate an upper state potential in a spatial dimension relative to said lower state potential. In some cases, the trapping optical source comprises at least two optical sources. In some cases, a first trapping optical source 520 is configured to trap the atom in a first (e.g., a lower state, a ground state, etc.) electronic state, and a second trapping optical source 510 is configured to trap the atom in the second (e.g., an upper state, a excited state, etc.) electronic state. In some cases, a trapping wavelength of the first trapping optical source is different than a trapping wavelength of the second trapping optical source. In some cases, the second (e.g., an upper state, an excited state, etc.) state potential feels substantially no optical dipole force from said first trapping optical source. In some cases, the first (e.g., a lower state, a ground state, etc.) state potential feels substantially no optical dipole force from the second trapping optical source.

The system may comprise an electromagnetic delivery unit 530. The electromagnetic delivery unit may be configured to produce an excitation electromagnetic energy, wherein the excitation electromagnetic energy is configured to excite said atom to said upper electronic state, and wherein a relative velocity of said excited state potential relative to said ground state potential substantially counteracts a momentum imparted by an exciting photon of said excitation electromagnetic energy.

Electromagnetic Delivery Unit—The electromagnetic delivery unit may be configured to apply electromagnetic energy to one or more atoms of the plurality of atoms, as described herein. The electromagnetic delivery unit may comprise one or more light sources, such as any light source described herein. The electromagnetic energy may comprise optical energy. The optical energy may comprise any repetition rate, pulse energy, average power, wavelength, or bandwidth described herein.

Laser—In some cases, the excitation electromagnetic energy is coherent light from a laser. The lasers may comprise one or more continuous wave lasers. The lasers may comprise one or more pulsed lasers. The lasers may comprise one or more gas lasers, such as one or more helium-neon (HeNe) lasers, argon (Ar) lasers, krypton (Kr) lasers, xenon (Xe) ion lasers, nitrogen (N₂) lasers, carbon dioxide (CO₂) lasers, carbon monoxide (CO) lasers, transversely excited atmospheric (TEA) lasers, or excimer lasers. For instance, the lasers may comprise one or more argon dimer (Ar₂) excimer lasers, krypton dimer (Kr₂) excimer lasers, fluorine dimer (F₂) excimer lasers, xenon dimer (Xe₂) excimer lasers, argon fluoride (ArF) excimer lasers, krypton chloride (KrCl) excimer lasers, krypton fluoride (KrF) excimer lasers, xenon bromide (XeBr) excimer lasers, xenon chloride (XeCl) excimer lasers, or xenon fluoride (XeF) excimer lasers. The laser may comprise one or more dye lasers.

The lasers may comprise one or more metal-vapor lasers, such as one or more helium-cadmium (HeCd) metal-vapor lasers, helium-mercury (HeHg) metal-vapor lasers, helium-selenium (HeSe) metal-vapor lasers, helium-silver (HeAg) metal-vapor lasers, strontium (Sr) metal-vapor lasers, neon-copper (NeCu) metal-vapor lasers, copper (Cu) metal-vapor lasers, gold (Au) metal-vapor lasers, manganese (Mn) metal-vapor laser, or manganese chloride (MnCl₂) metal-vapor lasers.

The lasers may comprise one or more solid-state lasers, such as one or more ruby lasers, metal-doped crystal lasers, or metal-doped fiber lasers. For instance, the lasers may comprise one or more neodymium-doped yttrium aluminum gamet (Nd:YAG) lasers, neodymium/chromium doped yttrium aluminum gamet (Nd/Cr:YAG) lasers, erbium-doped yttrium aluminum gamet (Er:YAG) lasers, neodymium-doped yttrium lithium fluoride (Nd:YLF) lasers, neodymium-doped yttrium orthovanadate (ND:YVO₄) lasers, neodymium-doped yttrium calcium oxoborate (Nd:YCOB) lasers, neodymium glass (Nd:glass) lasers, titanium sapphire (Ti:sapphire) lasers, thulium-doped ytrium aluminum gamet (Tm:YAG) lasers, ytterbium-doped ytrrium aluminum gamet (Yb:YAG) lasers, ytterbium-doped glass (Yt:glass) lasers, holmium ytrrium aluminum gamet (Ho:YAG) lasers, chromium-doped zinc selenide (Cr:ZnSe) lasers, cerium-doped lithium strontium aluminum fluoride (Ce:LiSAF) lasers, cerium-doped lithium calcium aluminum fluoride (Ce:LiCAF) lasers, erbium-doped glass (Er:glass) lasers, erbium-ytterbium-codoped glass (Er/Yt:glass) lasers, uranium-doped calcium fluoride (U:CaF₂) lasers, or samarium-doped calcium fluoride (Sm:CaF₂) lasers.

The lasers may comprise one or more semiconductor lasers or diode lasers, such as one or more gallium nitride (GaN) lasers, indium gallium nitride (InGaN) lasers, aluminum gallium indium phosphide (AlGaInP) lasers, aluminum gallium arsenide (AlGaAs) lasers, indium gallium arsenic phosphide (InGaAsP) lasers, vertical cavity surface emitting lasers (VCSELs), or quantum cascade lasers.

The lasers may emit continuous wave laser light. The lasers may emit pulsed laser light. The lasers may have a pulse length of at least about 1 femtoseconds (fs), 2 fs, 3 fs, 4 fs, 5 fs, 6 fs, 7 fs, 8 fs, 9 fs, 10 fs, 20 fs, 30 fs, 40 fs, 50 fs, 60 fs, 70 fs, 80 fs, 90 fs, 100 fs, 200 fs, 300 fs, 400 fs, 500 fs, 600 fs, 700 fs, 800 fs, 900 fs, 1 picosecond (ps), 2 ps, 3 ps, 4 ps, 5 ps, 6 ps, 7 ps, 8 ps, 9 ps, 10 ps, 20 ps, 30 ps, 40 ps, 50 ps, 60 ps, 70 ps, 80 ps, 90 ps, 100 ps, 200 ps, 300 ps, 400 ps, 500 ps, 600 ps, 700 ps, 800 ps, 900 ps, 1 nanosecond (ns), 2 ns, 3 ns, 4 ns, 5 ns, 6 ns, 7 ns, 8 ns, 9 ns, 10 ns, 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1,000 ns, or more. The lasers may have a pulse length of at most about 1,000 ns, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, 9 ns, 8 ns, 7 ns, 6 ns, 5 ns, 4 ns, 3 ns, 2 ns, 1 ns, 900 ps, 800 ps, 700 ps, 600 ps, 500 ps, 400 ps, 300 ps, 200 ps, 100 ps, 90 ps, 80 ps, 70 ps, 60 ps, 50 ps, 40 ps, 30 ps, 20 ps, 10 ps, 9 ps, 8 ps, 7 ps, 6 ps, 5 ps, 4 ps, 3 ps, 2 ps, 1 ps, 900 fs, 800 fs, 700 fs, 600 fs, 500 fs, 400 fs, 300 fs, 200 fs, 100 fs, 90 fs, 80 fs, 70 fs, 60 fs, 50 fs, 40 fs, 30 fs, 20 fs, 10 fs, 9 fs, 8 fs, 7 fs, 6 fs, 5 fs, 4 fs, 3 fs, 2 fs, 1 fs, or less. The lasers may have a pulse length that is within a range defined by any two of the preceding values.

The lasers may have a repetition rate of at least about 1 hertz (Hz), 2 Hz, 3 Hz, 4 Hz, 5 Hz, 6 Hz, 7 Hz, 8 Hz, 9 Hz, 10 Hz, 20 Hz, 30 Hz, 40 Hz, 50 Hz, 60 Hz, 70 Hz, 80 Hz, 90 Hz, 100 Hz, 200 Hz, 300 Hz, 400 Hz, 500 Hz, 600 W Hz, 700 Hz, 800 Hz, 900 Hz, 1 kilohertz (kHz), 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1 megahertz (MHz), 2 MHz, 3 MHz, 4 MHz, 5 MHz, 6 MHz, 7 MHz, 8 MHz, 9 MHz, 10 MHz, 20 MHz, 30 MHz, 40 MHz, 50 MHz, 60 MHz, 70 MHz, 80 MHz, 90 MHz, 100 MHz, 200 MHz, 300 MHz, 400 MHz, 500 MHz, 600 MHz, 700 MHz, 800 MHz, 900 MHz, 1,000 MHz, or more. The lasers may have a repetition rate of at most about 1,000 MHz, 900 MHz, 800 MHz, 700 MHz, 600 MHz, 500 MHz, 400 MHz, 300 MHz, 200 MHz, 100 MHz, 90 MHz, 80 MHz, 70 MHz, 60 MHz, 50 MHz, 40 MHz, 30 MHz, 20 MHz, 10 MHz, 9 MHz, 8 MHz, 7 MHz, 6 MHz, 5 MHz, 4 MHz, 3 MHz, 2 MHz, 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, 900 Hz, 800 Hz, 700 Hz, 600 Hz, 500 Hz, 400 Hz, 300 Hz, 200 Hz, 100 Hz, 90 Hz, 80 Hz, 70 Hz, 60 Hz, 50 Hz, 40 Hz, 30 Hz, 20 Hz, 10 Hz, 9 Hz, 8 Hz, 7 Hz, 6 Hz, 5 Hz, 4 Hz, 3 Hz, 2 Hz, 1 Hz, or less. The lasers may have a repetition rate that is within a range defined by any two of the preceding values.

The lasers may emit light having a pulse energy of at least about 1 nanojoule (nJ), 2 nJ, 3 nJ, 4 nJ, 5 nJ, 6 nJ, 7 nJ, 8 nJ, 9 nJ, 10 nJ, 20 nJ, 30 nJ, 40 nJ, 50 nJ, 60 nJ, 70 nJ, 80 nJ, 90 nJ, 100 nJ, 200 nJ, 300 nJ, 400 nJ, 500 nJ, 600 nJ, 700 nJ, 800 nj, 900 nJ, 1 microjoule (ρJ), 2 μJ, 3 μJ, 4 μJ, 5 μJ, 6 μJ, 7 μJ, 8 μJ, 9 μJ, 10 μJ, 20 μJ, 30 μJ, 40 μJ, 50 μJ, 60 μJ, 70 μJ, 80 μJ, 90 μJ, 100 μJ, 200 μJ, 300 μJ, 400 μJ, 500 μJ, 600 μJ, 700 μJ, 800 μJ, 900 μJ, a least 1 millijoule (mJ), 2 mJ, 3 mJ, 4 mJ, 5 mJ, 6 mJ, 7 mJ, 8 mJ, 9 mJ, 10 mJ, 20 mJ, 30 mJ, 40 mJ, 50 mJ, 60 mJ, 70 mJ, 80 mJ, 90 mJ, 100 mJ, 200 ml, 300 mJ, 400 mJ, 500 mJ, 600 mJ, 700 mJ, 800 mJ, 900 mJ, a least 1 Joule (J), or more. The lasers may emit light having a pulse energy of at most about 1 J, 900 mJ, 800 mJ, 700 mJ, 600 mJ, 5X) mJ, 400 mJ, 300 mJ, 200 mJ, 100 mJ, 90 mJ, 80 mJ, 70 mJ, 60 mJ, 50 mJ, 40 mJ, 30 mJ, 20 mJ, 10 mJ, 9 mJ, 8 mJ, 7 mJ, 6 mJ, 5 mJ, 4 mJ, 3 mJ, 2 mJ, 1 mJ, 900 μJ, 800 μJ, 700 μJ, 600 μJ, 500 μJ, 400 μJ, 300 μJ, 200 μJ, 100 μJ, 90 μJ, 80 μJ, 70 μJ, 60 μJ, 50 μJ, 40 μJ, 30 μJ, 20 μJ, 10 μJ, 9 μJ, 8 μJ, 7 μJ, 6 μJ, 5 μJ, 4 μJ, 3 μJ, 2 μJ, 1 μJ, 900 nJ, 800 nJ, 700 nJ, 600 nJ, 500 nJ, 400 nJ, 300 nJ, 200 nJ, 100 nJ, 90 nJ, 80 nJ, 70 nJ, 60 nJ, 50 nJ, 40 nJ, 30 nJ, 20 nJ, 10 nJ, 9 nJ, 8 nJ, 7 nJ, 6 nJ, 5 nJ, 4 nJ, 3 nJ, 2 nJ, 1 nJ, or less. The lasers may emit light having a pulse energy that is within a range defined by any two of the preceding values.

The lasers may emit light having an average power of at least about 1 microwatt (ρW), 2 μW, 3 μW, 4 μW, 5 μW, 6 μW, 7 μW, 8 μW, 9 μW, 10 μW, 20 μW, 30 μW, 40 μW, 50 μW, 60 μW, 70 μW, 80 μW, 90 μW, 100 μW, 200 μW, 300 μW, 400 μW, 500 μW, 600 μW, 700 μW, 800 μW, 900 μW, 1 milliwatt (mW), 2 mW, 3 mW, 4 mW, 5 mW, 6 mW, 7 mW, 8 mW, 9 mW, 10 mW, 20 mW, 30 mW, 40 mW, 50 mW, 60 mW, 70 mW, 80 mW, 90 mW, 100 mW, 200 mW, 300 mW, 400 mW, 500 mW, 600 mW, 700 mW, 800 mW, 900 mW, 1 watt (W), 2 W, 3 W, 4 W, 5 W, 6 W, 7 W, 8 W, 9 W, 10 W, 20 W, 30 W, 40 W, 50 W, 60 W, 70 W, 80 W, 90 W, 100 W, 200 W, 300 W, 400 W, 500 W, 600 W, 700 W, 800 W, 900 W, 1,000 W, or more. The lasers may emit light having an average power of at most about 1,000 W, 900 W, 800 W, 700 W, 600 W, 500 W, 400 W, 300 W, 200 W, 100 W, 90 W, 80 W, 70 W, 60 W, 50 W, 40 W, 30 W, 20 W, 10 W, 9 W, 8 W, 7 W, 6 W, 5 W, 4 W, 3 W, 2 W, 1 W, 900 mW, 800 mW, 700 mW, 600 mW, 500 mW, 400 mW, 300 mW, 200 mW, 100 mW, 90 mW, 80 mW, 70 mW, 60 mW, 50 mW, 40 mW, 30 mW, 20 mW, 10 mW, 9 mW, 8 mW, 7 mW, 6 mW, 5 mW, 4 mW, 3 mW, 2 mW, 1 mW, 900 μW, 800 μW, 700 μW, 600 μW, 500 μW, 400 μW, 300 μW, 200 μW, 100 μW, 90 μW, 80 μW, 70 μW, 60 μW, 50 μW, 40 μW, 30 μW, 20 μW, 10 μW, 9 μW, 8 μW, 7 μW, 6 μW, 5 μW, 4 μW, 3 μW, 2 μW, 1 μW, or more. The lasers may emit light having a power that is within a range defined by any two of the preceding values.

The lasers may emit light comprising one or more wavelengths in the ultraviolet (UV), visible, or infrared (IR) portions of the electromagnetic spectrum. The lasers may emit light a resonant transition between the first state and the second state. For example, the lasers may emit light a 399 nm ¹Sₒ to ¹P₁ transition, a 556 nm ¹S_{O} to ³P₁ transition, or a 578 nm ¹Sₒ to ³Pₒ clock transition. The lasers may emit light comprising one or more wavelengths of at least about 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, 1,010 nm, 1,020 nm, 1,030 nm, 1,040 nm, 1,050 nm, 1,060 nm, 1,070 nm, 1,080 nm, 1,090 nm, 1,100 nm, 1,110 nm, 1,120 nm, 1,130 nm, 1,140 nm, 1,150 nm, 1,160 nm, 1,170 nm, 1,180 nm, 1,190 nm, 1,200 nm, 1,210 nm, 1,220 nm, 1,230 nm, 1,240 nm, 1,250 nm, 1,260 nm, 1,270 nm, 1,280 nm, 1,290 nm, 1,300 nm, 1,310 nm, 1,320 nm, 1,330 nm, 1,340 nm, 1,350 nm, 1,360 nm, 1,370 nm, 1,380 nm, 1,390 nm, 1,400 nm, or more. The lasers may emit light comprising one or more wavelengths of at most about 1,400 nm, 1,390 nm, 1.380 nm, 1,370 n, 1,360 nm, 1,350 nm, 1,340 nm, 1,330 nm, 1,320 nm, 1,310 nm, 1,300 nm, 1,290 nm, 1,280 nm, 1,270 n, 1,260 nm, 1,250 nm, 1,240 nm, 1,230 nm, 1,220 nm, 1,210 nm, 1,200 nm, 1,190 nm, 1,180 nm, 1.170 n, 1,160 nm, 1,150 nm, 1,140 nm, 1,130 nm, 1,120 nm, 1,110 nm, 1,100 nm, 1,090 nm, 1,080 nm, 1,070 n, 1,060 nm, 1,050 nm, 1,040 nm, 1,030 nm, 1,020 nm, 1,010 nm, 1,000 nm, 990 nm, 980 nm, 970 nm, 960 nm, 950 nm, 940 nm, 930 nm, 920 nm, 910 nm, 900 nm, 890 nm 880 nm, 870 nm, 860 nm, 850 nm, 840 nm, 830 nm, 820 nm 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm. The lasers may emit light comprising one or more wavelengths that are within a range defined by any two of the preceding values.

The lasers may emit light having a bandwidth of at least about 1×10⁻¹⁵ nm, 2×10⁻¹⁵ nm, 3×10⁻¹⁵ nm, 4×10⁻¹⁵ nm, 5×10⁻¹⁵ nm, 6×10⁻¹⁵ nm, 7×10⁻⁴⁵ nm, 8×10⁻¹⁵ nm, 9×10⁻¹⁵ nm, 1×10⁻¹⁴ nm, 2×10⁻¹⁴ nm, 3×10⁻¹⁴ nm, 4×10⁻¹⁴ nm, 5×10⁻¹⁴ nm, 6×10⁻¹⁴ nm, 7×10⁻¹⁴ nm, 8×10⁻¹⁴ nm, 9×10⁻¹⁴ nm, 1×10⁻¹³ nm, 2×10⁻¹³ nm, 3×10⁻¹³ nm, 4×10⁻¹³ nm, 5×10⁻¹³ nm, 6×10⁻¹³ nm, 7×10⁻¹³ nm, 8×10⁻¹³ nm, 9×10⁻¹³ nm, 1×10⁻¹² nm, 2×10⁻¹² nm, 3×10⁻¹² nm, 4×10⁻¹² nm, 5×10⁻¹² nm, 6×10⁻¹² nm, 7×10⁻¹² nm, 8×10⁻¹² nm, 9×10⁻¹² nm, 1×10⁻¹¹ nm, 2×10⁻¹¹ nm, 3×10⁻¹¹ nm, 4×10⁻¹¹ nm, 5×10⁻¹¹ nm, 6×10⁻¹ nm, 7×10⁻¹¹ nm, 8×10⁻¹¹ nm, 9×10⁻¹¹ nm, 1×10⁻¹⁰ nm, 2×10⁻¹⁰ nm, 3×10⁻¹⁰ nm, 4×10⁻¹⁰ nm, 5×10⁻¹⁰ nm, 6×10⁻¹⁰ nm, 7×10⁻¹⁰ nm, 8×10⁻¹⁰ nm, 9×10⁻¹⁰ nm, 1×10⁻⁹ nm, 2×10⁻⁹ nm, 3×10⁻⁹ nm, 4×10⁻⁹ nm, 5×10⁻⁹ nm, 6×10⁻⁹ nm, 7×10⁻⁹ nm, 8×10⁻⁹ nm, 9×10⁹ nm, 1×10⁻⁸ nm, 2×10⁻⁸ nm, 3×10⁻⁸ nm, 4×10⁻⁸ nm, 5×10⁻⁸ nm, 6×10⁻⁸ nm, 7×10⁻⁸ nm, 8×10⁻⁸ nm, 9×10⁻⁸ nm, 1×10⁻⁷ nm, 2×10⁻⁷ nm, 3×10⁻⁷ nm, 4×10⁻⁷ nm, 5×10⁻⁷ nm, 6×10⁻⁷ nm, 7×10⁻⁷ nm, 8×10⁻⁷ nm, 9×10⁻⁷ nm, 1×10⁻⁶ nm, 2×10⁻⁶ nm, 3×10⁻⁶ nm, 4×10⁻⁶ nm, 5×10⁻⁶ nm, 6×10⁻⁶ nm, 7×10⁻⁶ nm, 8×10⁻⁶ nm, 9×10⁻⁶ nm, 1×10⁻⁵ nm, 2×10⁻⁵ nm, 3×10⁻⁵ nm, 4×10⁻⁵ nm, 5×10⁻⁵ nm, 6×10⁻⁵ nm, 7×10⁻⁵ nm, 8×10⁻⁵ nm, 9×10⁻⁵ nm, 1×10⁻⁴ nm, 2×10⁻⁴ nm, 3×10⁻⁴ nm, 4×10⁻⁴ nm, 5×10⁻⁴ nm, 6×10⁻⁴ nm, 7×10⁻⁴ nm, 8×10⁻⁴ nm, 9×10⁻⁴ nm, 1×10⁻³ nm, or more. The lasers may emit light having a bandwidth of at most about 1×10⁻³ nm, 9×10⁻⁴ nm, 8×10⁻⁴ nm, 7×10⁻⁴ nm, 6×10⁻⁴ nm, 5×10⁻⁴ nm, 4×10⁻⁴ nm, 3×10⁻⁴ nm, 2×10⁻⁴ nm, 1×10⁻⁴ nm, 9×10⁻⁵ nm, 8×10⁻⁵ nm, 7×10⁻⁵ nm, 6×10⁻⁵ nm, 5×10⁻⁵ nm, 4×10⁻⁵ nm, 3×10⁻⁵ nm, 2×10⁻⁵ nm, 1×10⁻⁵ nm, 9×10⁻⁶ nm, 8×10⁻⁶ nm, 7×10⁻⁶ nm, 6×10⁻⁶ nm, 5×10⁻⁶ nm, 4×10⁻⁶ nm, 3×10⁻⁶ nm, 2×10⁻⁶ nm, 1×10⁻⁶ nm, 9×10⁻⁷ nm, 8×10⁻⁷ nm, 7×10⁻⁷ nm, 6×10⁻⁷ nm, 5×10⁻⁷ nm, 4×10⁻⁷ nm, 3×10⁻⁷ nm, 2×10⁻⁷ nm, 1×10⁻⁷ nm, 9×10⁻⁸ nm, 8×10⁻⁸ nm, 7×10⁻⁸ nm, 6×10⁻⁸ nm, 5×10⁻⁸ nm, 4×10⁻⁸ nm, 3×10⁻⁸ nm, 2×10⁻⁸ nm, 1×10⁻⁸ nm, 9×10⁻⁹ nm, 8×10⁻⁹ nm, 7×10⁻⁹ nm, 6×10⁻⁹ nm, 5×10⁻⁹ nm, 4×10⁻⁹ nm, 3×10⁻⁹ nm, 2×10⁻⁹ nm, 1×10⁻⁹ nm, 9×10⁻¹⁰ nm, 8×10⁻¹⁰ nm, 7×10⁻¹⁰ nm, 6×10⁻¹⁰ nm, 5×10⁻¹⁰ nm, 4×10⁻¹⁰ nm, 3×10⁻¹⁰ nm, 2×10⁻¹⁰ nm, 1×10⁻¹⁰ nm, 9×10⁻¹¹ nm, 8×10⁻¹¹ nm, 7×10⁻¹¹ nm, 6×10⁻¹¹ nm, 5×10⁻¹¹ nm, 4×10⁻¹¹ nm, 3×10⁻¹¹ nm, 2×10⁻¹¹ nm, 1×10⁻¹⁰ nm, 9×10⁻¹² nm, 8×10⁻¹² nm, 7×10⁻¹² nm, 6×10⁻¹² nm, 5×10⁻¹² nm, 4×10⁻¹² nm, 3×10⁻¹² nm, 2×10⁻¹² nm, 1×10⁻¹² nm, 9×10⁻¹³ nm, 8×10⁻¹³ nm, 7×10⁻¹³ nm, 6×10⁻¹³ nm, 5×10⁻¹³ nm, 4×10⁻¹³ nm, 3×10⁻¹³ nm, 2×10⁻¹³ nm, 1×10⁻¹³ nm, 9×10⁻¹⁴ nm, 8×10⁻¹⁴ nm, 7×10⁻¹⁴ nm, 6×10⁻¹⁴ nm, 5×10⁻¹⁴ nm, 4×10⁻¹⁴ nm, 3×10⁻¹⁴ nm, 2×10⁻¹⁴ nm, 1×10⁻¹⁴ nm, 9×10⁻¹⁵ nm, 8×10⁻¹⁵ nm, 7×10⁻¹⁵ nm, 6×10⁻¹⁵ nm, 5×10⁻¹⁵ nm, 4×10⁻¹⁵ nm, 3×10⁻¹⁵ nm, 2×10⁻¹⁵ nm, 1×10⁻¹⁵ nm, or less. The lasers may emit light having a bandwidth that is within a range defined by any two of the preceding values.

In some examples, a “magic” potential could be used, where the wavelength of the trapping laser is chosen so that the ground and excited states have equal polarizability and therefore experience equal potentials. See, e.g., https://joumals.aps.org/prl/abstract/10.1103/PhysRevLett.100.103002, which is incorporated by reference herein for all purposes. Then, a linear potential gradient that acts differentially on the excited and ground states may be applied (e.g., a magnetic gradient if the ground and excited states have different magnetic moments, as described herein above). Changing the gradient in time may generate a translation between the ground and excited state potentials, similar to the method of tune-out wavelengths.

The light sources may be configured to emit light tuned to one or more magic wavelengths corresponding to the plurality of atoms. A magic wavelength corresponding to an atom may comprise any wavelength of light that gives rise to equal or nearly equal polarizabilities of the first and second atomic states. The magic wavelengths for a transition between the first and second atomic states may be determined by calculating the wavelength-dependent polarizabilities of the first and second atomic states and finding crossing points. Light tuned to such a magic wavelength may give rise to equal or nearly equal differential light shifts in the first and second atomic states, regardless of the intensity of the light emitted by the light sources. This may effectively decouple the first and second atomic states from motion of the atoms. The magic wavelengths may utilize one or more scalar or tensor light shifts. The scalar or tensor light shifts may depend on magnetic sublevels within the first and second atomic states.

### Non Classical Computation

The present disclosure provides systems and methods for performing a non-classical computation using methods and systems for preserving a motional state of an atom, such as those described with respect to FIG. 1, FIG. 2, FIG. 3, FIG. 4, FIG. 5, etc. In some cases, method 100 or method 300 further comprises performing a non-classical computation. In some cases, the non-classical computation is a quantum computation. The system 500 may comprise a portion of a non-classical computer.

A non-classical computation, non-classical procedure, non-classical operation, and non-classical computer may refer to any method or system for performing computational procedures outside of the paradigm of classical computing. A non-classical computation, non-classical procedure, non-classical operation, or non-classical computer may comprise a quantum computation, quantum procedure, quantum operation, or quantum computer.

A quantum computation, quantum procedure, quantum operation, or quantum computer may refer to any method or system for performing computations using quantum mechanical operations (such as unitary transformations or completely positive trace-preserving (CPTP) maps on quantum channels) on a Hilbert space represented by a quantum device. As such, quantum and classical (or digital) computation may be similar in the following aspect, both computations may comprise sequences of instructions performed on input information to then provide an output. Various paradigms of quantum computation may break the quantum operations down into sequences of basic quantum operations that affect a subset of qubits of the quantum device simultaneously. The quantum operations may be selected based on, for instance, their locality or their ease of physical implementation. A quantum procedure or computation may then consist of a sequence of such instructions that in various applications may represent different quantum evolutions on the quantum device. For example, procedures to compute or simulate quantum chemistry may represent the quantum states and the annihilation and creation operators of electron spin-orbitals by using qubits (such as two-level quantum systems) and a universal quantum gate set (such as the Hadamard, controlled-not (CNOT), and π/8 rotations) through the so-called Jordan-Wigner transformation or Bravyi-Kitaev transformation.

Additional examples of quantum procedures or computations may include procedures for optimization such as quantum approximate optimization algorithm (QAOA) or quantum minimum finding. QAOA may comprise performing rotations of single qubits and entangling gates of multiple qubits. In quantum adiabatic computation, the instructions may carry stochastic or non-stochastic paths of evolution of an initial quantum system to a final one.

Quantum-inspired procedures may include simulated annealing, parallel tempering, master equation solver. Monte Carlo procedures and the like. Quantum-classical or hybrid algorithms or procedures may comprise such procedures as variational quantum eigensolver (VQE) and the variational and adiabatically navigated quantum eigensolver (VanQver).

A quantum computer may comprise one or more adiabatic quantum computers, quantum gate arrays, one-way quantum computers, topological quantum computers, quantum Turing machines, quantum annealers, Ising solvers, or gate models of quantum computing. In some cases, the quantum computer may be a gate model quantum computer. In some cases, the quantum computer may be a quantum annealers.

The methods and systems of the present disclosure may be integrated with scalable neutral atom quantum computing systems of commonly owned International Patent Publication No. WO2020102256, which is incorporate herein by reference in its entirety.

### Computer Systems

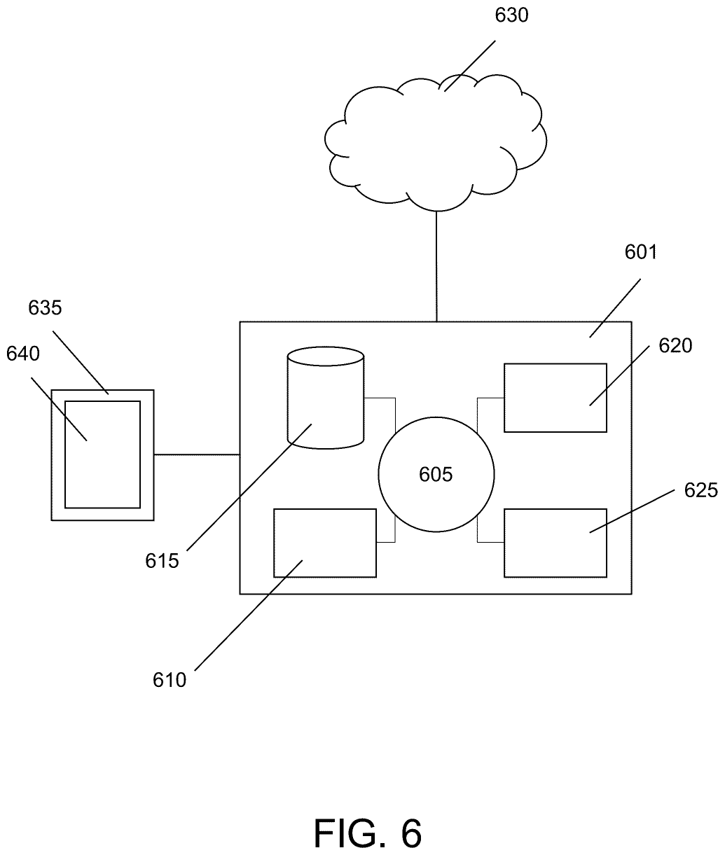

The present disclosure provides computer systems that are programmed to implement methods of the disclosure. FIG. 6 shows a computer system 601 that is programmed or otherwise configured to perform a method for exciting an atom while preserving a motional state of the atom. The computer system 601 can regulate various aspects of a system for performing a method for exciting an atom while preserving a motional state of the atom of the present disclosure, such as, for example, controlling one or more optical sources, controlling the operation of a non-classical computer comprising a plurality of neutral atoms, generating the translating excitation, etc. The computer system 601 can be an electronic device of a user or a computer system that is remotely located with respect to the electronic device. The electronic device can be a mobile electronic device.

The computer system 601 includes a central processing unit (CPU, also “processor” and “computer processor” herein) 605, which can be a single core or multi core processor, or a plurality of processors for parallel processing. The computer system 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 can be a data storage unit (or data repository) for storing data. The computer system 601 can be operatively coupled to a computer network (“network”) 630 with the aid of the communication interface 620. The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630, in some cases with the aid of the computer system 601, can implement a peer-to-peer network, which may enable devices coupled to the computer system 601 to behave as a client or a server.

The CPU 605 can execute a sequence of machine-readable instructions, which can be embodied in a program or software. The instructions may be stored in a memory location, such as the memory 610. The instructions can be directed to the CPU 605, which can subsequently program or otherwise configure the CPU 605 to implement methods of the present disclosure. Examples of operations performed by the CPU 605 can include fetch, decode, execute, and writeback.

The CPU 605 can be part of a circuit, such as an integrated circuit. One or more other components of the system 601 can be included in the circuit. In some cases, the circuit is an application specific integrated circuit (ASIC).

The storage unit 615 can store files, such as drivers, libraries and saved programs. The storage unit 615 can store user data, e.g., user preferences and user programs. The computer system 601 in some cases can include one or more additional data storage units that are external to the computer system 601, such as located on a remote server that is in communication with the computer system 601 through an intranet or the Internet.

The computer system 601 can communicate with one or more remote computer systems through the network 630. For instance, the computer system 601 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone. Android-enabled device, Blackberry®), or personal digital assistants. The user can access the computer system 601 via the network 630.

Methods as described herein can be implemented by way of machine (e.g., computer processor) executable code stored on an electronic storage location of the computer system 601, such as, for example, on the memory 610 or electronic storage unit 615. The machine executable or machine-readable code can be provided in the form of software. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 601, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables: copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 601 can include or be in communication with an electronic display 635 that comprises a user interface (UI) 640. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 605.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-89. (canceled)

90. A method for preserving a motional state of an atom when said atom is transitioned from a first state to a second state, the method comprising:
(a) providing said atom in said first state, wherein said atom is trapped at a trapping site of a plurality of spatially distinct optical trapping sites by a first state potential;
(b) translating a second state potential in a spatial dimension relative to said first state potential; and
(c) transitioning said atom to said second state with an excitation electromagnetic energy, and wherein a relative velocity of said second state potential relative to said first state potential substantially counteracts a momentum imparted by a photon of said excitation electromagnetic energy.

91. The method of claim 90, wherein a temporal duration of said excitation electromagnetic energy is short relative to a characteristic length of said first state potential.

92. The method of claim 90, wherein a characteristic trap frequency of said first state potential is substantially equal to a characteristic trap frequency of said second state potential.

93. The method of claim 90, wherein said translating said second state potential in (b) is performed substantially without altering a trapping potential of either said second state or said first state.

94. The method of claim 90, wherein a recoil velocity of said excitation electromagnetic energy is about equal to said relative velocity.

95. The method of claim 90, wherein said translating said second state potential in (b) comprises translating a magnetic field or providing a magnetic field gradient, and wherein said second state potential and said first state potential exhibit a differential sensitivity to said magnetic field or said magnetic field gradient.

96. The method of claim 90, wherein said translating said second state potential in (b) comprises:
trapping said first state and said second state with a trapping optical excitation, wherein said trapping optical excitation is tuned such that said first state and said second state have substantially equal polarizabilities; and
applying a potential gradient and changing said potential gradient in time.

97. The method of claim 90, wherein said translating in (b) comprises translating said second state potential, wherein said first state potential is substantially stationary, and wherein said translating is performed substantially without altering said first state potential.

98. The method of claim 90, wherein said plurality of atoms are qubits.

99. The method of claim 90, wherein the method further comprises performing a non-classical computation.

100. The method of claim 90, wherein said first state is a ground state and said second state is an excited state.

101. The method of claim 90, wherein said transitioning is an absorption or an emission.

102. A system for preserving a motional state of an atom when said atom is transitioned between states, the system comprising:
a plurality of spatially distinct optical trapping sites comprising an atom in a site of said plurality of spatially distinct optical trapping sites, wherein said atom is trapped by a first state potential;
a trapping optical source, wherein said trapping optical source is operable to translate a second state potential in a spatial dimension relative to said first state potential; and
an electromagnetic delivery unit, said electromagnetic delivery unit configured to produce an excitation electromagnetic energy, wherein said excitation electromagnetic energy is configured to transition said atom to said second electronic state, and wherein a relative velocity of said second state potential relative to said first state potential substantially counteracts a momentum imparted by a photon of said excitation electromagnetic energy.

103. The system of claim 102, wherein a temporal duration of said excitation electromagnetic energy is short relative to a characteristic length of said first state potential.

104. The system of claim 102, wherein a characteristic trap frequency of said first state potential is substantially equal to a characteristic trap frequency of said second state potential.

105. The system of claim 102, wherein said trapping optical source is configured to translate said second state potential substantially without altering a trapping potential of either said second state or said first state.

106. The system of claim 102, wherein a recoil velocity of said excitation electromagnetic energy is about equal to said relative velocity.

107. The system of claim 102, wherein said trapping optical source is configured to:
trap said first state and said second state with a trapping optical excitation, wherein said trapping optical excitation is tuned such that said first state and said second state have substantially equal polarizabilities; and
apply a potential gradient, and wherein translating said excite state potential comprises changing said potential gradient in time.

108. The system of claim 102, wherein said trapping optical source is configured to: translate said second state potential, wherein said first state potential is substantially stationary, and wherein said translating is performed substantially without altering said first state potential.

109. The system of claim 102, wherein said plurality of atoms are qubits.

110. The system of claim 102, wherein the system is a portion of a non-classical computer.

111. The system of claim 102, wherein said first state is a ground state and said second state is an excited state.

112. The system of claim 102, wherein said transitioning is an absorption or an emission.
